(19) United States
(12) Patent Application Publication
(10) Pub. No.: US 2026/0066189 A1
(43) Pub. Date: Mar. 5, 2026

(54) METALLIZED FILM, FILM CAPACITOR, INVERTER, AND VEHICLE

(71) Applicant: Panasonic Intellectual Property Management Co., Ltd., Osaka (JP)

(72) Inventors: Yuki KAWANO, Toyama (JP); Manato KADOMURA, Ishikawa (JP); Masanobu SHIMA, Toyama (JP)

(21) Appl. No.: 19/282,587

(22) Filed: Jul. 28, 2025

(30) Foreign Application Priority Data
Aug. 30, 2024 (JP) 2024-150368

(51) Int. Cl. H01G 4/33; H01G 2/16; H01G 4/012; H01G 4/228

(52) U.S. Cl. CPC H01G 4/33; H01G 2/16; H01G 4/012; H01G 4/228

(57) ABSTRACT

A metallized film includes a dielectric film and a metal film. The metal film includes: a larger electrode; two or more columns of smaller electrodes; and a plurality of fuses. Each of the two or more columns of smaller electrodes includes a plurality of smaller electrodes. Each of the fuses connects either the larger electrode and a corresponding one of the smaller electrodes adjacent to the larger electrode or adjacent ones of the smaller electrodes. The number of the fuses connected to each of the smaller electrodes is equal to the number of the fuses connected to any other one of the smaller electrodes. Each of the smaller electrodes included in one of the two or more columns of smaller electrodes that is located closest to the larger electrode is connected to the larger electrode via two or more of the fuses.

### CROSS-REFERENCE TO RELATED APPLICATIONS

The present application is based upon, and claims the benefit of priority to, Japanese Patent Application No. 2024-150368, filed on Aug. 30, 2024, the entire contents of which are hereby incorporated by reference.

### TECHNICAL FIELD

The present disclosure generally relates to a metallized film, a film capacitor, an inverter, and a vehicle. More particularly, the present disclosure relates to a metallized film including a dielectric film and a metal film, a film capacitor, an inverter, and a vehicle.

### BACKGROUND ART

WO 2024/084909 A1 (hereinafter referred to as “Patent Literature 1”) discloses a metallized film. In the metallized film, a metal is evaporated to form an insulating margin at one end of the width of a dielectric film.

The metallized film includes: divided electrodes formed by dividing the metal evaporated on the insulating margin by non-evaporated portions in the shape of slits; and fuses connected to the divided electrodes. A plurality of divided electrodes are arranged side by side along the width of the dielectric film.

Furthermore, each of two divided electrodes corresponding to the first and second columns as viewed from the insulating margin satisfies all of the following three conditions [1] to [3]:
[1] its area is equal to or larger than 15 mm²;
[2] four or more fuses are connected thereto; and
[3] the divided electrode is connected to every adjacent divided electrode via a single fuse.

The metallized film of Patent Literature 1 tries to reduce the excessive operation of the fuses by adopting this configuration.

However, Patent Literature 1 is silent about equivalent series resistance (ESR). The present inventors concluded, via experiments, that in the metallized film of Patent Literature 1, the relative arrangement of the divided electrodes and the fuses, for example, should be revised to reduce the ESR.

### SUMMARY

The present disclosure provides a metallized film which may be used suitably as a material for manufacturing a film capacitor with low ESR, a film capacitor with low ESR, and an inverter and a vehicle each including such a film capacitor.

A metallized film according to an aspect of the present disclosure includes: a dielectric film, for which a longitudinal direction and a width direction are defined; and a metal film provided on the dielectric film. The metal film includes: a larger electrode extending in the longitudinal direction; two or more columns of smaller electrodes arranged side by side in the width direction with respect to the larger electrode; and a plurality of fuses. Each of the two or more columns of smaller electrodes includes a plurality of smaller electrodes that are arranged in the longitudinal direction. Each of the plurality of fuses connects together either the larger electrode and a corresponding one of the smaller electrodes which is adjacent to the larger electrode or adjacent ones of the smaller electrodes. A numerical number of the fuses connected to each of the plurality of smaller electrodes is equal to a numerical number of the fuses connected to any other one of the plurality of smaller electrodes. Each of the plurality of smaller electrodes included in one of the two or more columns of smaller electrodes that is located closer to the larger electrode in the width direction than any other one of the two or more columns of smaller electrodes is connected to the larger electrode via two or more of the plurality of fuses.

A film capacitor according to another aspect of the present disclosure includes the metallized film described above.

An inverter according to still another aspect of the present disclosure includes the film capacitor described above.

A vehicle according to yet another aspect of the present disclosure includes the inverter described above.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a schematic plan view illustrating a (first variation of a) metallized film according to an exemplary embodiment;

FIG. 2 is a schematic plan view illustrating a (second variation of the) metallized film according to the exemplary embodiment;

FIG. 3 is a schematic plan view illustrating a (third variation of the) metallized film according to the exemplary embodiment;

FIG. 4 is a schematic plan view illustrating a (fourth variation of the) metallized film according to the exemplary embodiment;

FIG. 5 is a schematic plan view illustrating a (fifth variation of the) metallized film according to the exemplary embodiment;

FIG. 6 is a schematic plan view illustrating a (sixth variation of the) metallized film according to the exemplary embodiment;

FIG. 7 is a schematic plan view illustrating a (seventh variation of the) metallized film according to the exemplary embodiment;

FIG. 8 is a schematic plan view illustrating an (eighth variation of the) metallized film according to the exemplary embodiment;

FIG. 9 is a schematic plan view illustrating a (ninth variation of the) metallized film according to the exemplary embodiment;

FIG. 10 is a schematic perspective view illustrating a film capacitor according to the exemplary embodiment;

FIG. 11 is a schematic perspective view illustrating an exemplary manufacturing process step of the film capacitor;

FIG. 12 is a block diagram of an inverter according to the exemplary embodiment; and

FIG. 13 is a schematic representation illustrating a vehicle according to the exemplary embodiment.

### DETAILED DESCRIPTION

### 1. Overview

To overcome the problem with the metallized film of Patent Literature 1, the present inventors carried out extensive research and development. As a result, the present inventors successfully developed a metallized film 1 having the following configuration:

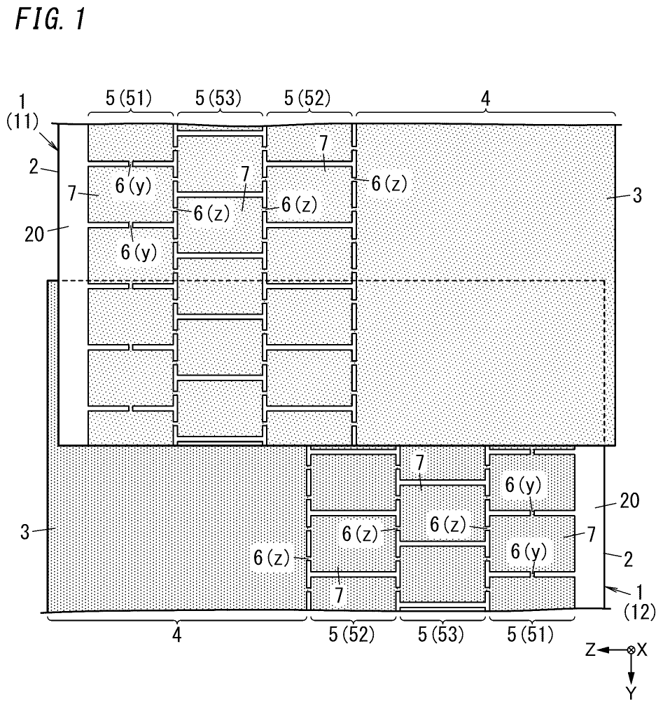

Specifically, a metallized film 1 according to an exemplary embodiment includes: a dielectric film 2, for which a longitudinal direction Y and a width direction Z are defined; and a metal film 3 provided on the dielectric film 2 (refer to FIGS. 1-9). The metal film 3 includes: a larger electrode 4 extending in the longitudinal direction Y; two or more columns 5 of smaller electrodes (namely, an outer column 51, an intermediate column 53, and an inner column 52) arranged side by side in the width direction Z with respect to the larger electrode 4; and a plurality of fuses 6 (including lateral fuses 6z and vertical fuses 6y). Each of the two or more columns 5 of smaller electrodes includes a plurality of smaller electrodes 7 that are arranged in the longitudinal direction Y. Each of the plurality of fuses 6 connects together either the larger electrode 4 and a corresponding one of the smaller electrodes 7 which is adjacent to the larger electrode 4 or adjacent ones of the smaller electrodes 7.

The present inventors discovered that a combination of the following two configurations would contribute effectively to reducing the ESR. Specifically, one of the two configurations is that the number of the fuses 6 connected to each of the plurality of smaller electrodes 7 is equal to the number of the fuses 6 connected to any other one of the plurality of smaller electrodes 7. The other configuration is that each of the plurality of smaller electrodes 7 included in one (i.e., the inner column 52) of the two or more columns 5 of smaller electrodes that is located closer to the larger electrode 4 in the width direction Z than any other one of the two or more columns 5 of smaller electrodes is connected to the larger electrode 4 via two or more of the fuses 6.

Thus, the metallized film 1 according to this embodiment may be used suitably as a material for manufacturing a film capacitor 10A with low equivalent series resistance (ESR).

### 2. Details

### (1) Metallized Film

A metallized film 1 according to this embodiment will now be described with reference to FIGS. 1-9. Note that the drawings to be referred to in the following description of embodiments are all schematic representations. Thus, the ratio of the dimensions (including thicknesses) of respective constituent elements illustrated on the drawings does not always reflect their actual dimensional ratio.

Note that even though arrows indicating respective directions are shown on the drawings, these arrows are just shown there as an assistant to description and are insubstantial ones. It should also be noted that these directions do not define the directions in which the metallized film 1 according to this embodiment should be used.

In FIGS. 1-9, X, Y and Z directions of an orthogonal coordinate system are defined. Specifically, the “X direction” herein defines a thickness direction with respect to the metallized film 1. In the following description, the “+X direction” will sometimes refer to the downward direction and “−X direction” will sometimes refer to the upward direction. The “Y direction” herein defines a longitudinal direction with respect to the metallized film 1. In the following description, the “+Y direction” will sometimes refer to the forward direction and “−Y direction” will sometimes refer to the backward direction. The “Z direction” herein defines a width direction with respect to the metallized film 1. In the following description, the “+Z direction” will sometimes refer to the leftward direction and “−Z direction” will sometimes refer to the rightward direction.

The metallized film 1 according to this embodiment may be configured as, without limitation, any of the first through ninth variations shown in FIGS. 1-9, respectively. In each of FIGS. 1-9, illustrated is a stack of two metallized films 1 (namely, a first metallized film 11 and a second metallized film 12). The second metallized film 12 is a mirror-reversed version of the first metallized film 11. Thus, the following description will be focused on the first metallized film 11 with the description of the second metallized film 12 omitted herein. In the following description, when a “metallized film 1” is mentioned simply, the metallized film 1 will refer to the first metallized film 11 unless otherwise stated.

### (1.1) First Variation

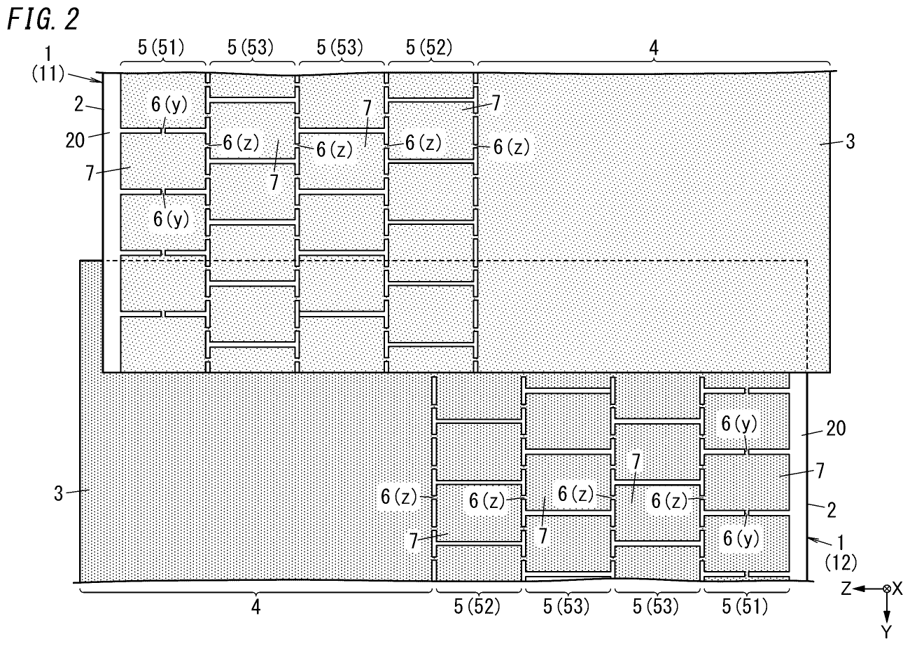

First of all, a first variation will be described with reference to FIG. 1. The metallized film 1 includes a dielectric film 2 and a metal film 3. In FIG. 1, the metal film 3 is represented by a dotted pattern. The same statement applies to each of FIGS. 2-9.

### <Dielectric Film>

A longitudinal direction Y and a width direction Z are defined with respect to the dielectric film 2. That is to say, the dielectric film 2 has an elongate shape and has a certain width.

Examples of materials for the dielectric film 2 include, without limitation, polypropylene (PP), polyethylene terephthalate (PET), polyethylene naphthalate (PEN), polyphenylene sulfide (PPS), polycarbonate (PC), and polystyrene (PS).

The thickness of the dielectric film 2 may be, without limitation, equal to or greater than 1 μm and equal to or less than 30 μm. Setting the thickness of the dielectric film 2 at a value equal to or greater than 1 μm may reduce the dielectric breakdown. Setting the thickness of the dielectric film 2 at a value equal to or less than 30 μm may increase the capacitance of the film capacitor 10A.

### <Metal Film>

The metal film 3 is provided on the dielectric film 2. In this embodiment, the metal film 3 is provided on only one side of the dielectric film 2. The metal film 3 may be formed by, for example, evaporation.

Examples of materials for the metal film 3 include, without limitation, aluminum (Al), gold (Au), magnesium (Mg), zinc (Zn), tin (Sn), nickel (Ni), chromium (Cr), iron (Fe), copper (Cu), titanium (Ti), and alloys thereof.

The metal film 3 includes a larger electrode 4, two or more (e.g., three in this first variation) columns 5 of smaller electrodes, and a plurality of fuses 6. Note that the number of the columns 5 of smaller electrodes is not limited to any upper limit unless the advantages of this embodiment are impaired.

### «Larger Electrode»

The larger electrode 4 extends in the longitudinal direction Y. That is to say, the larger electrode 4 has an elongate shape and has a certain width. The width of the larger electrode 4 is almost one half the width of the dielectric film 2. In this embodiment, the larger electrode 4 is disposed on almost the right half of the dielectric film 2. That is to say, the larger electrode 4 covers an area of the dielectric film 2 from a right end portion thereof through approximately its middle in the width direction Z. Note that in the second metallized film 12, the larger electrode 4 is disposed on almost the left half of the dielectric film 2. That is to say, the larger electrode 4 of the second metallized film 12 covers an area of the dielectric film 2 from a left end portion thereof through approximately its middle in the width direction Z.

### «Columns of Smaller Electrodes»

The two or more columns 5 of smaller electrodes are arranged in the width direction Z with respect to the larger electrode 4. In this embodiment, the two or more columns 5 of smaller electrodes are arranged on almost the left half of the dielectric film 2. Nevertheless, there is a margin portion 20 at the left end portion of the metallized film 1. Thus, the two or more columns 5 of smaller electrodes are interposed in the width direction Z between the larger electrode 4 and the margin portion 20. There is no metal film 3 in the margin portion 20. The margin portion 20 is a part where the dielectric film 2 is exposed, has the shape of a narrow strip with a certain width, and extends in the longitudinal direction Y.

In the second metallized film 12 on the other hand, the two or more columns 5 of smaller electrodes are arranged on almost the right half of the dielectric film 2. Nevertheless, there is a margin portion 20 at the right end portion of the second metallized film 12. Thus, the two or more columns 5 of smaller electrodes are interposed in the width direction Z between the larger electrode 4 and the margin portion 20. The margin portion 20 of the second metallized film 12 is also a part where the dielectric film 2 is exposed, also has the shape of a narrow strip with a certain width, and also extends in the longitudinal direction Y.

Each of the two or more columns 5 of smaller electrodes extends in the longitudinal direction Y. Each of the two or more columns 5 of smaller electrodes includes a plurality of smaller electrodes 7. That is to say, in each column 5 of smaller electrodes, the plurality of smaller electrodes 7 are arranged in the longitudinal direction Y.

The two or more columns 5 of smaller electrodes include an outer column 51, an inner column 52, and an intermediate column 53.

The outer column 51 is a column 5 of smaller electrodes which is located most distant in the width direction Z from the larger electrode 4. In other words, the outer column 51 is a column 5 of smaller electrodes which is located closest to the margin portion 20 in the width direction Z. That is to say, the outer column 51 is a column 5 of smaller electrodes which is located adjacent to the margin portion 20. As can be seen, only one outer column 51 is included in the metal film 3.

The inner column 52 is a column 5 of smaller electrodes which is located closest to the larger electrode 4 in the width direction Z. That is to say, the inner column 52 is a column 5 of smaller electrodes which is located adjacent to the larger electrode 4. As can be seen, only one inner column 52 is included in the metal film 3.

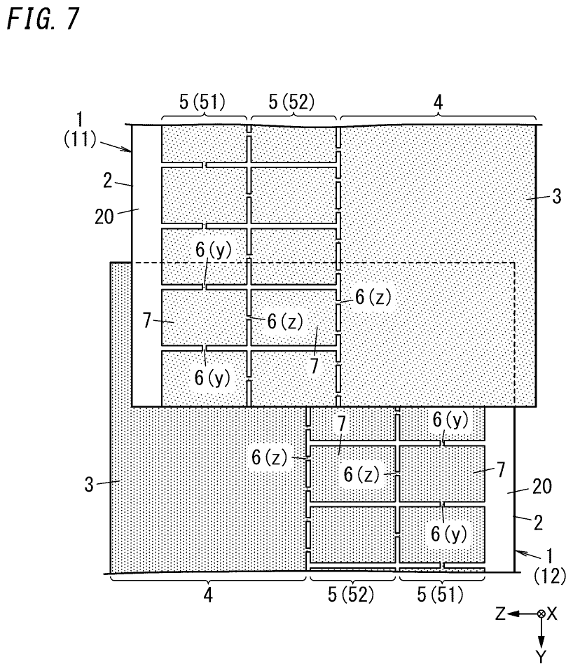

The intermediate column 53 is a column 5 of smaller electrodes which is located in the width direction Z between the outer column 51 and the inner column 52. In the first variation, the metal film 3 includes the intermediate column 53. However, this is only an example and should not be construed as limiting. Alternatively, the metal film 3 may include no intermediate columns 53 as in the seventh variation to be described later (refer to FIG. 7).

### [Smaller Electrode]

In this embodiment, each of the smaller electrodes 7 has a rectangular shape. Two opposing sides (i.e., the right and left sides) of the smaller electrode 7 are parallel to the longitudinal direction Y and the other two sides (i.e., the front and rear sides) thereof are parallel to the width direction Z.

Furthermore, in this embodiment, all the smaller electrodes 7 included in the two or more columns 5 of smaller electrodes have approximately the same shape and the same dimensions.

### «Fuse»

Each of the fuses 6 is fused when an excessive current flows due to, for example, the dielectric breakdown of the dielectric film 2. Each of the plurality of fuses 6 connects (a) the larger electrode 4 to a smaller electrode 7 adjacent to the larger electrode 4 or (b) a pair of smaller electrodes 7 adjacent to each other.

As used herein, the phrase (a) “connecting the larger electrode 4 to a smaller electrode 7 adjacent to the larger electrode 4” means connecting the larger electrode 4 to any one of the plurality of smaller electrodes 7 included in the inner column 52. In this embodiment, each of the plurality of smaller electrodes 7 included in the inner column 52 is connected to the larger electrode 4 via two or more (e.g., two in this first variation) fuses 6. Such a fuse 6 that connects the electrodes in the width direction Z will be hereinafter referred to as a “lateral fuse 6z.”

On the other hand, the phrase (b) “connecting a pair of smaller electrodes 7 adjacent to each other” means both (b1) connecting a pair of smaller electrodes 7 which are adjacent to each other in the width direction Z and (b2) connecting a pair of smaller electrodes 7 which are adjacent to each other in the longitudinal direction Y.

As for (b1), in this embodiment, each of the smaller electrodes 7 included in the outer column 51 is connected to corresponding ones of the smaller electrodes 7 included in the intermediate column 53 via fuses 6 (i.e., the lateral fuses 6z). In addition, each of the smaller electrodes 7 included in the intermediate column 53 is connected to corresponding ones of the smaller electrodes 7 included in the inner column 52 via fuses 6 (i.e., the lateral fuses 6z).

On the other hand, as for (b2), in this embodiment, two smaller electrodes 7 located adjacent to each other in the longitudinal direction Y which belong to the plurality of smaller electrodes 7 included in the outer column 51 are connected to each other via a fuse 6. Such a fuse 6 that connects a pair of smaller electrodes 7 in the longitudinal direction Y will be hereinafter referred to as a “vertical fuse 6y.”

Also, in this embodiment, no pair of smaller electrodes 7 located adjacent to each other in the longitudinal direction Y which belong to any of the two or more columns 5 of smaller electrodes (i.e., the intermediate column 53 and the inner column 52 in this first variation) but the outer column 51 are connected to each other via any fuse 6 (vertical fuse 6y).

Furthermore, the width of each of the plurality of fuses 6 preferably falls within the range equal to or greater than −80% and equal to or less than +80%, more preferably falls within the range equal to or greater than −50% and equal to or less than +50%, and even more preferably falls within the range equal to or greater than −20% and equal to or less than +20%, with respect to an average width of the plurality of fuses 6 as a reference value. Particularly if the width of each of the plurality of fuses 6 falls within the range equal to or greater than −20% and equal to or less than +20%, with respect to the average width of the plurality of fuses 6 as a reference value, then the respective widths of the plurality of fuses 6 are regarded as being equal to each other. In this embodiment, the respective widths of the plurality of fuses 6 are all equal to each other. That is to say, the width of the lateral fuse 6z and the width of the vertical fuse 6y are equal to each other. Note that the “width” of each fuse 6 herein refers to the dimension of the fuse 6 as measured perpendicularly to the direction in which the fuse 6 extends.

Furthermore, the length of each of the plurality of fuses 6 preferably falls within the range equal to or greater than −80% and equal to or less than +80%, more preferably falls within the range equal to or greater than −50% and equal to or less than +50%, and even more preferably falls within the range equal to or greater than −20% and equal to or less than +20%, with respect to an average length of the plurality of fuses 6 as a reference value. Particularly if the length of each of the plurality of fuses 6 falls within the range equal to or greater than −20% and equal to or less than +20%, with respect to the average length of the plurality of fuses 6 as a reference value, then the respective lengths of the plurality of fuses 6 are regarded as being equal to each other. In this embodiment, the respective lengths of the plurality of fuses 6 are all equal to each other. That is to say, the length of the lateral fuse 6z and the length of the vertical fuse 6y are equal to each other. Note that the “length” of each fuse 6 herein refers to the dimension of the fuse 6 as measured in the direction in which the fuse 6 extends.

Also, in the first variation, the number of fuses 6 connected to each of the plurality of smaller electrodes 7 is four. Specifically, two lateral fuses 6z and two vertical fuses 6y are connected to each of the smaller electrodes 7 included in the outer column 51. Four lateral fuses 6z are connected to each of the smaller electrodes 7 included in the intermediate column 53. Four lateral fuses 6z are connected to each of the smaller electrodes 7 included in the inner column 52. As can be seen, the same number of fuses 6 are connected to each of the plurality of smaller electrodes 7.

Furthermore, in the first variation, in two columns 5 of smaller electrodes which are adjacent to each other in the width direction Z, each of the smaller electrodes 7 included in one of the two columns 5 of smaller electrodes and corresponding ones of the smaller electrodes 7 included in the other of the two columns 5 of smaller electrodes are misaligned with each other in the width direction Z. The first variation will be described below with specific columns 5 of smaller electrodes applied to the “one column 5 of smaller electrodes” and “the other column 5 of smaller electrodes.”

Specifically, if the outer column 51 and the intermediate column 53 are applied to the “one column 5 of smaller electrodes” and “the other column 5 of smaller electrodes,” respectively, it can be seen that each of the smaller electrodes 7 included in the outer column 51 and corresponding ones of the smaller electrodes 7 included in the intermediate column 53 adjacent to the outer column 51 are misaligned with each other in the width direction Z. Misaligning each of the smaller electrodes 7 included in the outer column 51 with corresponding ones of the smaller electrodes 7 included in the intermediate column 53 in this manner makes it easier to connect each smaller electrode 7 included in the outer column 51 to a plurality of (e.g., two in this first variation) smaller electrodes 7 included in the intermediate column 53 via the fuses 6 (lateral fuses 6z). In the same way, this also makes it easier to connect each smaller electrode 7 included in the intermediate column 53 to a plurality of (e.g., two in this first variation) smaller electrodes 7 included in the outer column 51 via the fuses 6 (lateral fuses 6z).

Specifically, if the intermediate column 53 and the inner column 52 are applied to the “one column 5 of smaller electrodes” and “the other column 5 of smaller electrodes,” respectively, it can be seen that each of the smaller electrodes 7 included in the intermediate column 53 and corresponding ones of the smaller electrodes 7 included in the inner column 52 are misaligned with each other in the width direction Z. Misaligning each of the smaller electrodes 7 included in the intermediate column 53 with corresponding ones of the smaller electrodes 7 included in the inner column 52 adjacent to the intermediate column 53 in this manner makes it easier to connect each smaller electrode 7 included in the intermediate column 53 to a plurality of (e.g., two in this first variation) smaller electrodes 7 included in the inner column 52 via the fuses 6 (lateral fuses 6z). In the same way, this also makes it easier to connect each smaller electrode 7 included in the inner column 52 to a plurality of (e.g., two in this first variation) smaller electrodes 7 included in the intermediate column 53 via the fuses 6 (lateral fuses 6z).

In this embodiment, a determination whether a pair of smaller electrodes 7 adjacent to each other in the width direction Z are aligned with each other may be made by determining whether either a front side or rear side of one smaller electrode 7 is on the same straight line (i.e., a line parallel to the width direction Z) with any of a front side or rear side of the other smaller electrode 7. That is to say, if either a front side or rear side of one smaller electrode 7 is on the same straight line with any of a front side or rear side of the other smaller electrode 7, then a decision is made that these two smaller electrodes 7 be aligned with each other. On the other hand, if neither a front side nor rear side of one smaller electrode 7 is on the same straight line with any of a front side or rear side of the other smaller electrode 7, then a decision is made that these two smaller electrodes 7 be misaligned with each other.

### (1.2) Second Variation

Next, a second variation will be described with reference to FIG. 2. In the second variation, the number of intermediate columns 53 provided is larger by one than the number of intermediate columns 53 provided in the first variation, which is a difference from the first variation. In the other respects, the second variation has the same configuration as the first variation.

### (1.3) Third Variation

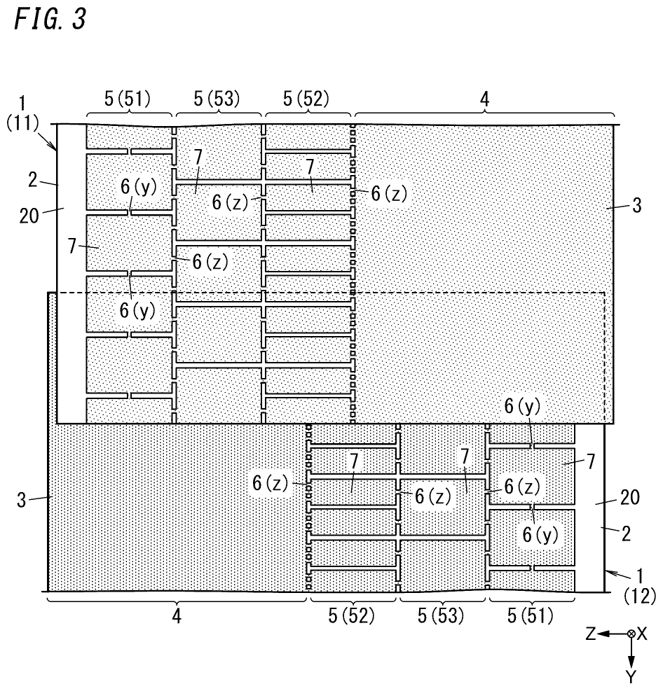

Next, a third variation will be described with reference to FIG. 3. The following description of the third variation will be focused on differences between the third variation and the first and second variations with the description of their common features omitted herein.

In the third variation, the number of fuses 6, via which each of the plurality of smaller electrodes 7 included in the inner column 52 is connected to the larger electrode 4, is larger than the number of fuses 6, via which the smaller electrode 7 is connected to another smaller electrode 7 (i.e., a smaller electrode 7 included in the intermediate column 53 adjacent to the inner column 52). Specifically, each smaller electrode 7 included in the inner column 52 is connected to a smaller electrode 7 included in the intermediate column 53 via one fuse 6 (lateral fuse 6z) and is connected to the larger electrode 4 via three fuses 6 (lateral fuses 6z).

In addition, in this third variation, not all the smaller electrodes 7 included in two or more columns 5 of smaller electrodes have the same shape and same dimensions. Specifically, the smaller electrodes 7 included in the outer column 51 and the smaller electrodes 7 included in the intermediate column 53 have almost the same shape and same dimensions but each of the smaller electrodes 7 included in the inner column 52 is smaller than any of the smaller electrodes 7 included in the intermediate column 53. More specifically, the front and rear sides of each of the smaller electrodes 7 included in the inner column 52 are almost as long as the front and rear sides of any of the smaller electrodes 7 included in the intermediate column 53. However, the right and left sides of each of the smaller electrodes 7 included in the inner column 52 are almost one half as long as the right and left sides of any of the smaller electrodes 7 included in the intermediate column 53. As can be seen, the size of each of the smaller electrodes 7 included in the inner column 52 is approximately one half of the size of any of the smaller electrodes 7 included in the intermediate column 53.

### (1.4) Fourth Variation

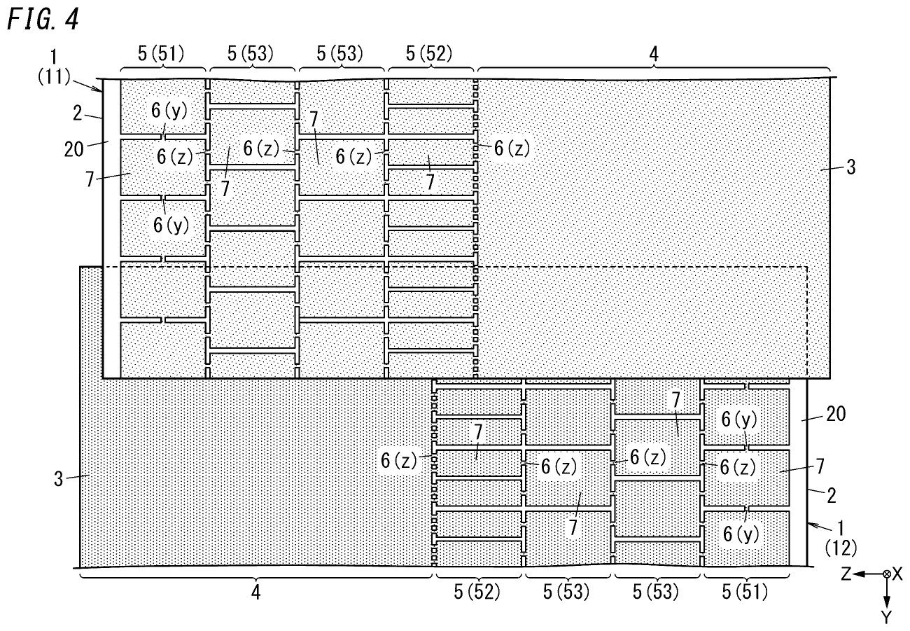

Next, a fourth variation will be described with reference to FIG. 4. In the fourth variation, the number of intermediate columns 53 provided is larger by one than the number of intermediate columns 53 provided in the third variation, which is a difference from the third variation. In the other respects, the fourth variation has the same configuration as the third variation.

### (1.5) Fifth Variation

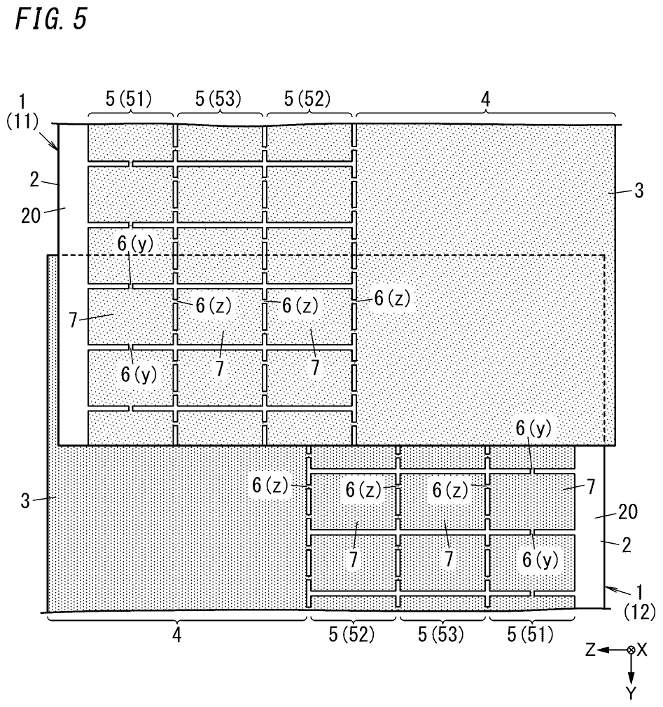

Next, a fifth variation will be described with reference to FIG. 5. The following description of the fifth variation will be focused on differences between the fifth variation and the first to fourth variations with the description of their common features omitted herein.

In the fifth variation, in two columns 5 of smaller electrodes which are adjacent to each other in the width direction Z, each of the smaller electrodes 7 included in one of the two columns 5 of smaller electrodes and a corresponding one of the smaller electrodes 7 included in the other of the two columns 5 of smaller electrodes are aligned with each other in the width direction Z. The fifth variation will be described below with specific columns 5 of smaller electrodes applied to the “one column 5 of smaller electrodes” and “the other column 5 of smaller electrodes.”

Specifically, if the outer column 51 and the intermediate column 53 are applied to the “one column 5 of smaller electrodes” and “the other column 5 of smaller electrodes,” respectively, it can be seen that each of the smaller electrodes 7 included in the outer column 51 and a corresponding one of the smaller electrodes 7 included in the intermediate column 53 are aligned with each other in the width direction Z.

Specifically, if the intermediate column 53 and the inner column 52 are applied to the “one column 5 of smaller electrodes” and “the other column 5 of smaller electrodes,” respectively, it can be seen that each of the smaller electrodes 7 included in the intermediate column 53 and a corresponding one of the smaller electrodes 7 included in the inner column 52 are aligned with each other in the width direction Z.

As can be seen, in this fifth variation, the front side of each of the smaller electrodes 7 included in the outer column 51, the front side of a corresponding one of the smaller electrodes 7 included in the intermediate column 53, and the front side of a corresponding one of the smaller electrodes 7 included in the inner column 52 are on the same straight line (i.e., a straight line parallel to the width direction Z). In the same way, the rear side of each of the smaller electrodes 7 included in the outer column 51, the rear side of a corresponding one of the smaller electrodes 7 included in the intermediate column 53, and the rear side of a corresponding one of the smaller electrodes 7 included in the inner column 52 are on the same straight line.

### (1.6) Sixth Variation

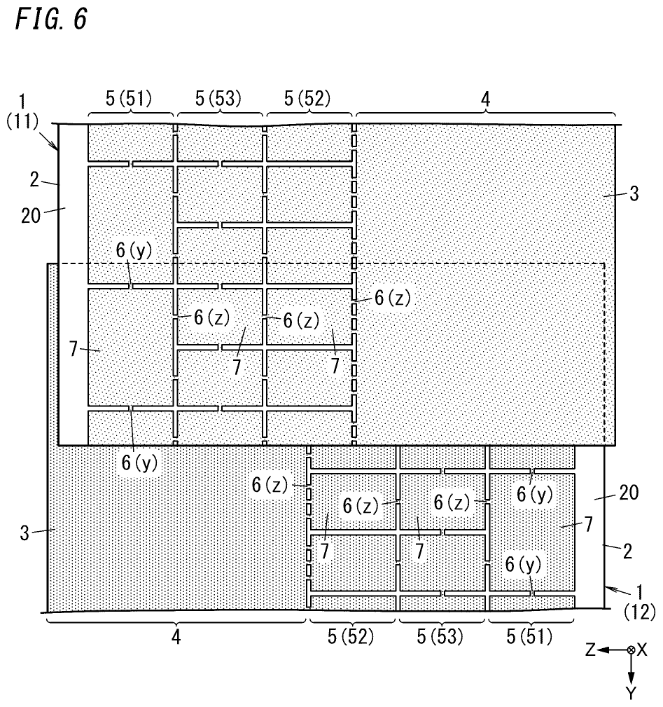

Next, a sixth variation will be described with reference to FIG. 6. The following description of the sixth variation will be focused on differences between the sixth variation and the first to fifth variations with the description of their common features omitted herein.

In this sixth variation, not all the smaller electrodes 7 included in two or more columns 5 of smaller electrodes have the same shape and same dimensions. Specifically, the smaller electrodes 7 included in the intermediate column 53 and the smaller electrodes 7 included in the inner column 52 have almost the same shape and same dimensions but each of the smaller electrodes 7 included in the outer column 51 are larger than any of the smaller electrodes 7 included in the intermediate column 53. More specifically, the front and rear sides of each of the smaller electrodes 7 included in the outer column 51 are almost as long as the front and rear sides of any of the smaller electrodes 7 included in the intermediate column 53. However, the right and left sides of each of the smaller electrodes 7 included in the outer column 51 are almost twice as long as the right and left sides of any of the smaller electrodes 7 included in the intermediate column 53. As can be seen, the size of each of the smaller electrodes 7 included in the outer column 51 is approximately twice the size of any of the smaller electrodes 7 included in the intermediate column 53.

In the sixth variation, in two columns 5 of smaller electrodes which are adjacent to each other in the width direction Z, each of the smaller electrodes 7 included in one of the two columns 5 of smaller electrodes and a corresponding one of the smaller electrodes 7 included in the other of the two columns 5 of smaller electrodes are aligned with each other in the width direction Z. The sixth variation will be described below with specific columns 5 of smaller electrodes applied to the “one column 5 of smaller electrodes” and “the other column 5 of smaller electrodes.” Specifically, if the outer column 51 and the intermediate column 53 are applied to the “one column 5 of smaller electrodes” and “the other column 5 of smaller electrodes,” respectively, it can be seen that each of the smaller electrodes 7 included in the outer column 51 and a corresponding one of the smaller electrodes 7 included in the intermediate column 53 are aligned with each other in the width direction Z. This respect will be described supplementally. Although the smaller electrodes 7 included in the outer column 51 each have a different size from the smaller electrodes 7 included in the intermediate column 53, either the front side or rear side of each of the smaller electrodes 7 included in the outer column 51 and any of the front side or rear side of a corresponding one of the smaller electrodes 7 included in the intermediate column 53 are on the same straight line. Thus, each of the smaller electrodes 7 included in the outer column 51 is aligned with a corresponding one of the smaller electrodes 7 included in the intermediate column 53.

### (1.7) Seventh Variation

Next, a seventh variation will be described with reference to FIG. 7. The following description of the seventh variation will be focused on differences between the seventh variation and the first to sixth variations with the description of their common features omitted herein.

The metallized film 1 according to each of the first to sixth variations described above includes the intermediate column 53, while the metallized film 1 according to the seventh variation includes no intermediate columns 53. That is to say, the seventh variation corresponds to the fifth variation (refer to FIG. 5) from which the intermediate column 53 is removed. Thus, in the seventh variation, the outer column 51 and the inner column 52 are adjacent to each other.

In addition, in the first to sixth variations, four fuses 6 are connected to each smaller electrode 7. In the seventh variation, on the other hand, three fuses 6 are connected to each smaller electrode 7.

### (1.8) Eighth Variation

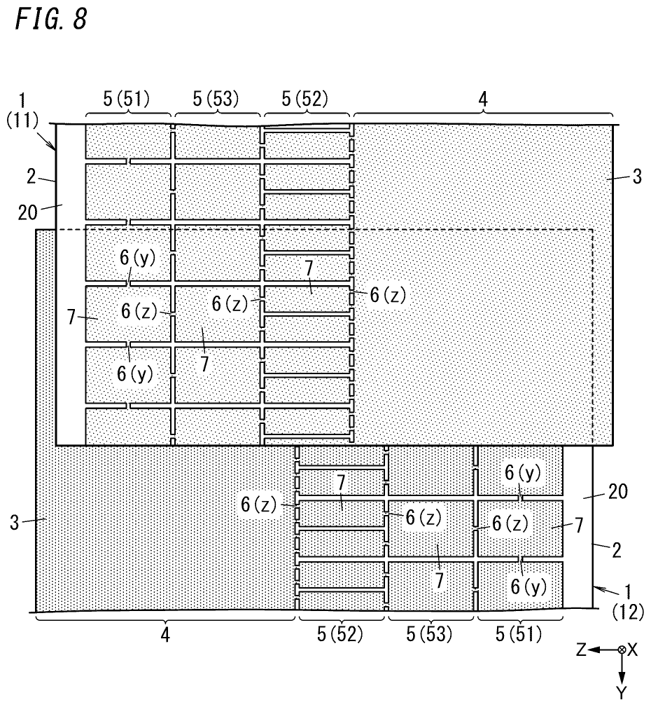

Next, an eighth variation will be described with reference to FIG. 8. The following description of the eighth variation will be focused on differences between the eighth variation and the first to seventh variations with the description of their common features omitted herein.

Comparing the eighth variation with the third variation (refer to FIG. 3), in particular, it can be seen that each of the smaller electrodes 7 included in the outer column 51 is misaligned in the third variation with a corresponding one of the smaller electrodes 7 included in the intermediate column 53 but each of the smaller electrodes 7 included in the outer column 51 is aligned in the eighth variation with a corresponding one of the smaller electrodes 7 included in the intermediate column 53.

In addition, in the third variation, four fuses 6 are connected to each smaller electrode 7. In the eighth variation, on the other hand, three fuses 6 are connected to each smaller electrode 7.

### (1.9) Ninth Variation

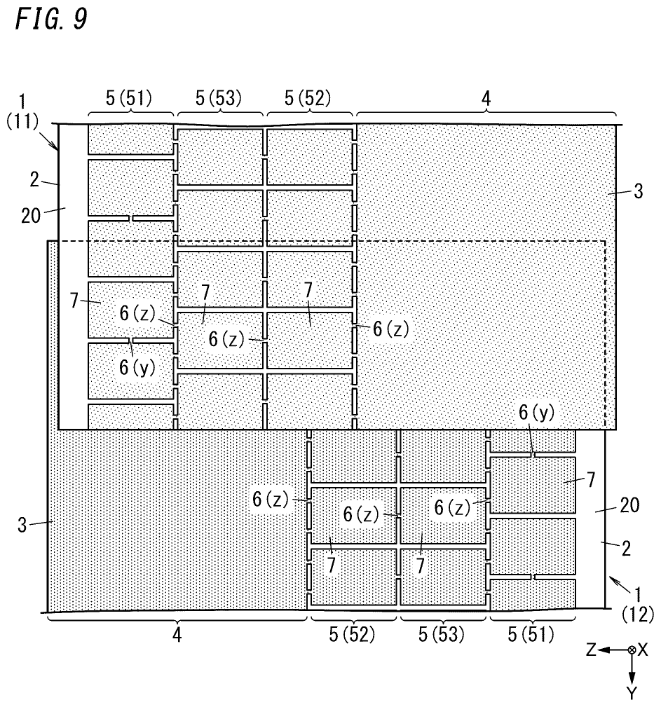

Next, a ninth variation will be described with reference to FIG. 9. The following description of the ninth variation will be focused on differences between the ninth variation and the first to eighth variations with the description of their common features omitted herein.

Comparing the ninth variation with the fifth variation (refer to FIG. 5), in particular, it can be seen that each of the smaller electrodes 7 included in the outer column 51 is aligned in the fifth variation with a corresponding one of the smaller electrodes 7 included in the intermediate column 53 but each of the smaller electrodes 7 included in the outer column 51 is misaligned in the ninth variation with a corresponding one of the smaller electrodes 7 included in the intermediate column 53.

In addition, in the fifth variation, each of the smaller electrodes 7 included in the outer column 51 is connected, via the vertical fuses 6y, to both the smaller electrodes 7 which are located forward and backward of the smaller electrode 7. In the ninth variation, on the other hand, each of the smaller electrodes 7 included in the outer column 51 is connected, via the vertical fuse 6y, to one smaller electrode 7 which is located either forward or backward of the smaller electrode 7.

Furthermore, in the fifth variation, four fuses 6 are connected to each smaller electrode 7. In the ninth variation, on the other hand, three fuses 6 are connected to each smaller electrode 7.

### <Advantages>

The metallized film 1 according to this embodiment may be used suitably as a material for manufacturing a film capacitor 10A with low equivalent series resistance (ESR).

Among other things, features that contribute to reducing the ESR include the feature that the same number of fuses 6 (i.e., four fuses 6 in the first to sixth variations and three fuses 6 in the seventh to ninth variations) are connected to each smaller electrode 7 and the feature that each of the smaller electrodes 7 included in the inner column 52 is connected to the larger electrode 4 via two or more fuses 6 (i.e., two fuses 6 in the first, second, fifth, and seventh to ninth variations and three fuses 6 in the third, fourth, and sixth variations).

Connecting the same number of fuses 6 to each smaller electrode 7 as described above makes it easier to equalize the sensitivities of the fuses 6 with respect to all smaller electrodes 7. Connecting different number of fuses 6 to the plurality of smaller electrodes 7 would cause a dispersion in the sensitivity of the fuses 6, which is not beneficial. This is because in that case, when a short-circuit occurs, the amount of current flowing through each smaller electrode 7 will be the same but the fusibility of the fuses 6 will vary from one point to another.

Furthermore, in this embodiment, the plurality of fuses 6 all have the same width, thus making it easier to equalize the sensitivities of the fuses 6 with each other.

Furthermore, in this embodiment, each pair of smaller electrodes 7 located adjacent to each other in the longitudinal direction Y which belong to a plurality of smaller electrodes 7 included in the outer column 51 are connected to each other via a fuse 6 (vertical fuse 6y). This makes it easier to make the number of fuses 6 connected to each smaller electrode 7 included in the outer column 51 equal to the number of fuses 6 connected to each smaller electrode 7 included in any column 5 of smaller electrodes (i.e., any of the intermediate column 53 or the inner column 52) but the outer column 51. That is to say, it makes it easier to equalize the number of fuses 6 connected to each smaller electrode 7. In addition, this may also reduce the chances of causing an inconvenience that the smaller electrodes 7 included in the outer column 51 are isolated and lose their proper function as electrodes when the fuses 6 surrounding any smaller electrode 7 included in the intermediate column 53 or the inner column 52 are fused. That is to say, this may reduce the chances of causing an excessive decrease in the capacitance of the film capacitor 10A.

If a film capacitor 10A (to be described later) is manufactured using the metallized film 1 according to this embodiment to charge and discharge the film capacitor 10A, then a current tends to flow more easily in the width direction Z than in the longitudinal direction Y inside the metallized film 1. As can be seen, the current flows mainly in the width direction Z. In that case, the fuse 6 extending in the width direction Z contributes to reducing the ESR more effectively than the fuse 6 extending in the longitudinal direction Y. That is to say, the lateral fuse 6z contributes to reducing the ESR more effectively than the vertical fuse 6y. In addition, the more distant from the larger electrode 4 the location of the vertical fuse 6y is, the better.

Thus, in this embodiment, no pair of smaller electrodes 7 included in the inner column 52 are connected to each other via any vertical fuse 6y (refer to the first to ninth variations described above). It is also preferable that no pair of smaller electrodes 7 included in the intermediate column 53 be connected to each other via any vertical fuse 6y (refer to the first to fifth variations and the seventh to ninth variations described above). Consequently, the equivalent series resistance (ESR) may be further reduced.

Comparing the fifth variation (refer to FIG. 5) of the exemplary embodiment with the first variation (refer to FIG. 1) thereof, it can be seen that each pair of smaller electrodes 7 adjacent to each other in the width direction Z are aligned with each other in the fifth variation but are misaligned with each other in the first variation. Look at each of the smaller electrodes 7 included in the intermediate column 53, and it can be seen that each of the smaller electrodes 7 included in the intermediate column 53 is connected in the fifth variation to only two smaller electrodes 7 via the lateral fuses 6z. In the first variation, on the other hand, each of the smaller electrodes 7 included in the intermediate column 53 is connected to four smaller electrodes 7 via the lateral fuses 6z. Misaligning each pair of smaller electrodes 7 which are adjacent to each other in the width direction Z as in the first variation allows the number of smaller electrodes 7 included in other columns 5 of smaller electrodes (e.g., the outer column 51 or the inner column 52) which are adjacent to each smaller electrode 7 included in one column 5 of smaller electrodes (e.g., the intermediate column 53) to be increased. This may also reduce the chances of causing an inconvenience that when the fuses 6 surrounding any smaller electrode 7 are fused, the smaller electrodes 7 surrounding the former smaller electrode 7 are isolated and lose their proper function as electrodes. That is to say, this may reduce the chances of causing an excessive decrease in the capacitance of the film capacitor 10A.

Furthermore, in the third, fourth, and sixth to ninth variations (refer to FIGS. 3, 4, and 6-9) of the exemplary embodiment, the number of fuses 6, via which each of the plurality of smaller electrodes 7 included in the inner column 52 is connected to the larger electrode 4, is larger than the number of fuses 6, via which the smaller electrode 7 is connected to a corresponding one of the smaller electrodes 7 included in the intermediate column 53. Making a difference in the number of fuses 6 connected in this manner may further reduce the equivalent series resistance (ESR).

Among the first to ninth variations of the metallized film 1, the first to fourth variations of the metallized film 1 are preferred from the viewpoint of reducing the ESR. In the two or more column 5 of smaller electrodes, the inner column 52 is located closest to the larger electrode 4. Then, the amount of current is maximum at points where each of the plurality of smaller electrodes 7 included in the inner column 52 is connected to the larger electrode 4 (i.e., at the fuse 6). Thus, increasing the number of fuses 6 (lateral fuses 62) at those points contributes significantly to reducing the ESR. In addition, the orientation of the lateral fuses 6z is substantially aligned with the direction in which the current flows, which also contributes to reducing the ESR.

### (2) Film Capacitor

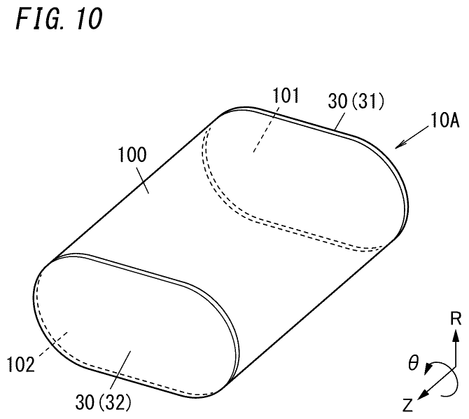

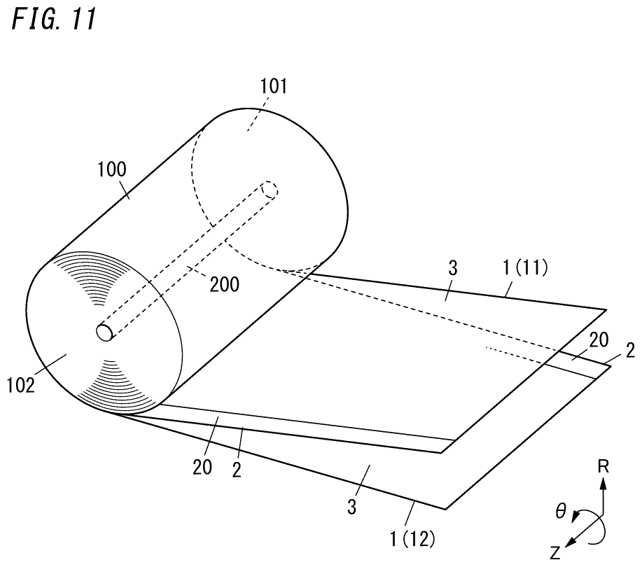

Next, a film capacitor 10A (capacitor element) according to this embodiment will be described with reference to FIGS. 10 and 11. The drawings to be referred to in the following description of embodiments are all schematic representations. Thus, the ratio of the dimensions (including thicknesses) of respective constituent elements illustrated on the drawings does not always reflect their actual dimensional ratio.

Note that even though arrows indicating respective directions are shown on the drawings, these arrows are just shown there as an assistant to description and are insubstantial ones. It should also be noted that these directions do not define the directions in which the film capacitor 10A according to this embodiment should be used.

In FIGS. 10 and 11, Z, R, and 0 directions of a cylindrical coordinate system are defined. The Z direction is an axial direction defined with respect to a roll 100. The +Z direction is a direction pointing from a first end surface 101 toward a second end surface 102. The −Z direction is opposite from the +Z direction. The R direction is a radial direction defined with respect to the roll 100. The +R direction is a direction pointing away from a core 200. The −R direction is opposite from the +R direction. The 0 direction is a direction in which the metallized film 1 is wound.

The X direction corresponds to the R direction of the cylindrical coordinate system. The Y direction corresponds to the 0 direction of the cylindrical coordinate system. The Z direction corresponds to the Z direction of the cylindrical coordinate system. Thus, in the following description, as for the Z direction of each of the cylindrical coordinate system and the orthogonal coordinate system, the +Z direction will be hereinafter referred to as “one side of the axial direction” and the −Z direction will be hereinafter referred to as “the other side of the axial direction.”

As shown in FIG. 10, the film capacitor 10A includes the roll 100 and a pair of end surface electrodes 30.

### <Roll>

The roll 100 is the body of the film capacitor 10A. The roll 100 has the shape of a rectangular column with rounded corners which extends in the axial direction (i.e., the Z direction). That is to say, when viewed in the axial direction, the roll 100 has the shape of a rectangle with rounded corners. The rectangle with rounded corners has a shape formed by connecting two semi-circles, of which the diameters are defined by the shorter sides of a rectangle, to the respective shorter sides of the rectangle. The roll 100 may have any shape without limitation. Examples of the shapes of the roll 100 include a circular columnar shape and an oval columnar shape.

The roll 100 has a first end surface 101 and a second end surface 102. The first end surface 101 is a surface facing the other side of the axial direction. The second end surface 102 is opposite from the first end surface 101. That is to say, the second end surface 102 is a surface facing one side of the axial direction.

As shown in FIG. 11, the roll 100 includes the core 200 and the metallized films 1 (namely, the first metallized film 11 and the second metallized film 12). As can be seen, the film capacitor 10A includes the metallized films 1. Note that in FIG. 11, the metal film 3 is illustrated in a simplified form.

The core 200 is a roll of a film with electrical insulation properties. Examples of materials for the film include, without limitation, polypropylene (PP) and polyethylene terephthalate (PET).

### <Pair of End Surface Electrodes>

As shown in FIG. 10, the pair of end surface electrodes 30 are provided for both end surfaces of the roll 100. Specifically, the pair of end surface electrodes 30 are a first end surface electrode 31 and a second end surface electrode 32.

The first end surface electrode 31 is formed by thermally spraying a metal onto the first end surface 101 of the roll 100. The second end surface electrode 32 is formed by thermally spraying a metal onto the second end surface 102 of the roll 100. Examples of the metal as a constituent material for the first end surface electrode 31 and the second end surface electrode 32 include, without limitation, zinc (Zn), tin (Sn), and alloys thereof.

The end edge of the metal film 3 of the first metallized film 11 is exposed at the first end surface 101 of the roll 100, and therefore, is in contact with the first end surface electrode 31. Thus, the first end surface electrode 31 is electrically connected to the metal film 3 of the first metallized film 11.

On the other hand, the end edge of the metal film 3 of the second metallized film 12 is exposed at the second end surface 102 of the roll 100, and therefore, is in contact with the second end surface electrode 32. Thus, the second end surface electrode 32 is electrically connected to the metal film 3 of the second metallized film 12.

The metal film 3 of the first metallized film 11 is spaced from the second end surface electrode 32 via the margin portion 20. Thus, the metal film 3 of the first metallized film 11 is out of contact with the second end surface electrode 32.

On the other hand, the metal film 3 of the second metallized film 12 is spaced from the first end surface electrode 31 via the margin portion 20. Thus, the metal film 3 of the second metallized film 12 is out of contact with the first end surface electrode 31.

### <Manufacturing Method>

The film capacitor 10A may be manufactured in the following manner. First, as shown in FIG. 11, a circular columnar roll 100 is formed by winding the metallized films 1 around the core 200. In this case, a stack of the first metallized film 11 and the second metallized film 12 is wound around the core 200 such that the metal film 3 and the dielectric film 2 are alternately laid one on top of the other.

Next, the roll 100 in the shape of a rectangular column with rounded corners is obtained by compressing the circular columnar roll 100 (refer to FIG. 10). In this process step, the compression is done by pressing the circular columnar roll 100 in the radial direction (i.e., in the R direction).

Next, a pair of end surface electrodes 30 are formed by thermally spraying a metal onto the first end surface 101 and second end surface 102 of the roll 100 thus compressed. In this manner, the film capacitor 10A (capacitor element) shown in FIG. 10 is obtained. Optionally, although not shown, a bus bar may be connected, as needed, to each of the pair of end surface electrodes 30. The film capacitor 10A may be housed in a case and encapsulated with a resin.

### <Advantages>

The film capacitor 10A according to this embodiment uses the metallized films 1 described above, and therefore, makes it easier to reduce the ESR.

### (3) Inverter

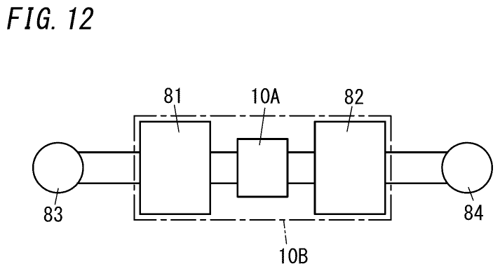

Next, an inverter 10B according to this embodiment will be described with reference to FIG. 12. The inverter 10B includes the film capacitor 10A, a converter circuit 81, and an inverter circuit 82.

The converter circuit 81 is a circuit for converting an alternating current into a direct current and is electrically connected to the film capacitor 10A.

The inverter circuit 82 is a circuit for changing the voltage and/or frequency of the alternating current when the direct current is converted into the alternating current, and is electrically connected to the film capacitor 10A.

The inverter 10B may be used in the following manner, for example. Specifically, the converter circuit 81 of the inverter 10B is connected to a power supply 83 and the inverter circuit 82 of the inverter 10B is connected to a motor 84. Note that the power supply 83 and the motor 84 are included in external devices.

The alternating current supplied from the power supply 83 is converted first by the converter circuit 81 of the inverter 10B into a direct current. Thereafter, the film capacitor 10A rectifies the direct current thus converted into a stabilized direct current while repeatedly performing charging and discharging operations. Next, this direct current is converted by the inverter circuit 82 of the inverter 10B into an alternating current at any voltage and frequency, which is output eventually.

### <Advantages>

The inverter 10B according to this embodiment uses the film capacitor 10A described above, and therefore, may improve the efficiency of the circuit and minimize the power loss.

### (4) Vehicle

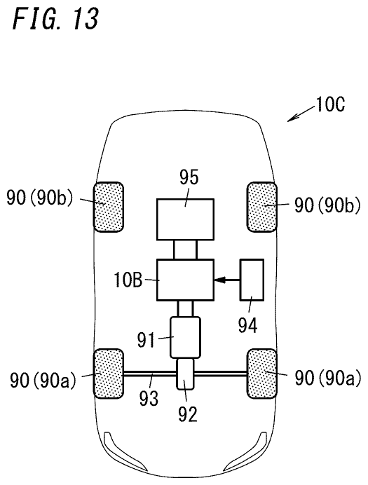

Next, a vehicle 10C according to this embodiment will be described with reference to FIG. 13. The following description will be focused on the drive system of the vehicle 10C.

The vehicle 10C includes the inverter 10B, an AC motor 91, a transmission 92, a battery 94, an electronic control unit 95, wheels 90 (including front wheels 90a and rear wheels 90b), a front axle 93, and a rear axle (not shown). The vehicle 10C is an electric vehicle (EV) designed to travel using the AC motor 91 as a drive source.

The vehicle 10C adopts the front wheel drive (FF) system. In the front part of the vehicle body, arranged are the AC motor 91 as a drive source and the transmission 92. The transmission 92 changes the rotational speed of the AC motor 91 and transmits the rotational speed thus changed to the front axle 93.

The front axle 93 is disposed horizontally with respect to the vehicle width direction. The front wheels 90a are mounted as a drive wheels at right and left ends of the front axle 93. In the rear part of the vehicle body, the rear axle (not shown) is disposed along the width of the vehicle to be parallel to the front axle 93. The rear wheels 90b are mounted at the right and left ends of the rear axle.

The battery 94 is a DC power supply. The DC power supplied from the battery 94 is converted by the inverter 10B into AC power, which is then supplied to the AC motor 91. With this AC power, the AC motor 91 is driven in rotation. The driving force (output) of the AC motor 91 is controlled via the inverter 10B which operates in accordance with a control signal supplied from the electronic control unit 95.

### <Advantages>

The vehicle 10C according to this embodiment uses the inverter 10B described above, thus reducing the heat generated by the film capacitor 10A and thereby extending the life of the film capacitor 10A. Consequently, this may reduce the frequency of occurrence of the repair and maintenance of the film capacitor 10A.

### 3. Variations

In the exemplary embodiment described above, the width of the larger electrode 4 is approximately one half the width of the dielectric film 2. However, this is only an example and should not be construed as limiting. That is to say, the width of the larger electrode 4 may also be broader or narrower than one half the width of the dielectric film 2, whichever is appropriate. Particularly if the width of the larger electrode 4 is narrower than one half the width of the dielectric film 2, the width of the larger electrode 4 may be, for example, approximately equal to the width of the margin portion 20. In that case, two or more columns 5 of smaller electrodes will be arranged over approximately the entire width of the dielectric film 2.

In the embodiment described above, the larger electrode 4 is a single continuous electrode in the longitudinal direction Y. Alternatively, the larger electrode 4 may be divided into multiple parts.

In the embodiment described above, the number of the intermediate columns 53 included in the metal film 3 is equal to or greater than zero and equal to or less than two. However, the upper limit of the number of intermediate columns 53 is not limited to any particular value unless the advantages of this embodiment are impaired.

In the embodiment described above, the smaller electrodes 7 each have a rectangular shape. Alternatively, each smaller electrode 7 may have any other shape (such as a diamond or hexagonal shape).

In the embodiment described above, the film capacitor 10A is a wound one. Alternatively, the film capacitor 10A may also be a stacked one.

In the embodiment described above, the vehicle 10C has been described as an electric vehicle (EV). Alternatively, the vehicle 10C may also be a hybrid electric vehicle (HEV) including an engine and an AC motor as its drive sources.

### 4. Aspects

As can be seen from the foregoing description of an exemplary embodiment and its variations, the present disclosure has the following aspects. In the following description, reference signs are added in parentheses to the respective constituent elements solely for the purpose of clarifying correspondence between the following aspects of the present disclosure and the exemplary embodiments described above.

A first aspect is a metallized film (1) which includes: a dielectric film (2), for which a longitudinal direction (Y) and a width direction (Z) are defined; and a metal film (3) provided on the dielectric film (2). The metal film (3) includes: a larger electrode (4) extending in the longitudinal direction (Y); two or more columns (5) of smaller electrodes arranged side by side in the width direction (Z) with respect to the larger electrode (4); and a plurality of fuses (6). Each of the two or more columns (5) of smaller electrodes includes a plurality of smaller electrodes (7) that are arranged in the longitudinal direction (Y). Each of the plurality of fuses (6) connects together either the larger electrode (4) and a corresponding one of the smaller electrodes (7) which is adjacent to the larger electrode (4) or adjacent ones of the smaller electrodes (7). A numerical number of the fuses (6) connected to each of the plurality of smaller electrodes (7) is equal to a numerical number of the fuses (6) connected to any other one of the plurality of smaller electrodes (7). Each of the plurality of smaller electrodes (7) included in one of the two or more columns (5) of smaller electrodes that is located closer to the larger electrode (4) in the width direction (Z) than any other one of the two or more columns (5) of smaller electrodes is connected to the larger electrode (4) via two or more of the plurality of fuses (6).

According to this aspect, the metallized film (1) is suitably usable as a material for manufacturing a film capacitor (10A) with low equivalent series resistance (ESR).

Specific examples of the metallized film (1) according to the first aspect include the first to ninth variations described above.

A second aspect is a metallized film (1) which may be implemented in conjunction with the first aspect. In the second aspect, two smaller electrodes (7) located adjacent to each other in the longitudinal direction (Y) which belong to the plurality of smaller electrodes (7) included in an outer column (51) are connected to each other via a corresponding one of the plurality of fuses (6). The outer column (51) is located more distant in the width direction (Z) from the larger electrode (4) than any other one of the two or more columns (5) of smaller electrodes.

This aspect makes it easier to equalize the number of fuses (6) connected to each of the smaller electrodes (7) included in the outer column (51) with the number of fuses (6) connected to any of the smaller electrodes (7) included in the columns (5) of smaller electrodes but the outer column (51).

Specific examples of the metallized film (1) according to the second aspect include the first to ninth variations described above.

A third aspect is a metallized film (1) which may be implemented in conjunction with the first or second aspect. In the third aspect, two smaller electrodes (7) located adjacent to each other in the longitudinal direction (Y) which belong to each of the two or more columns (5) of smaller electrodes but an outer column (51) are not connected via any of the plurality of fuses (6). The outer column (51) is located more distant in the width direction (Z) from the larger electrode (4) than any other one of the two or more columns (5) of smaller electrodes.

This aspect allows the equivalent series resistance (ESR) to be further reduced.

Specific examples of the metallized film (1) according to the third aspect include the first to fifth variations described above and the seventh to ninth variations described above.

A fourth aspect is a metallized film (1) which may be implemented in conjunction with any one of the first to third aspects. In the fourth aspect, a numerical number of the fuses (6) connected to each of the plurality of smaller electrodes (7) is four.

This aspect makes it easier to equalize the sensitivities of the fuses (6) with each other with respect to all the smaller electrodes (7).

Specific examples of the metallized film (1) according to the fourth aspect include the first to sixth variations described above.

A fifth aspect is a metallized film (1) which may be implemented in conjunction with any one of the first to fourth aspects. In the fifth aspect, in two columns (5) of smaller electrodes which are adjacent to each other in the width direction (Z), each of the smaller electrodes (7) included in one of the two columns (5) of smaller electrodes and corresponding ones of the smaller electrodes (7) included in a remaining one of the two columns (5) of smaller electrodes are misaligned with each other in the width direction (Z).

This aspect allows for increasing the number of smaller electrodes (7) located adjacent to each smaller electrode (7) in one column (5) of smaller electrodes which belong to another column (5) of smaller electrodes.

Specific examples of the metallized film (1) according to the fifth aspect include the first to fourth variations described above and the ninth variation described above.

A sixth aspect is a metallized film (1) which may be implemented in conjunction with any one of the first to fifth aspects. In the sixth aspect, in each of the plurality of smaller electrodes (7) included in a column (5) of smaller electrodes located closer in the width direction (Z) to the larger electrode (4) than any other one of the two or more columns (5) of smaller electrodes, a numerical number of the fuses (6) connected to the larger electrode (4) is larger than a numerical number of the fuses (6) connected to any other one of the plurality of smaller electrodes (7).

This allows the equivalent series resistance (ESR) to be further reduced.

Specific examples of the metallized film (1) according to the sixth aspect include the third, fourth, and sixth to ninth variations described above.

A seventh aspect is a metallized film (1) which may be implemented in conjunction with any one of the first to sixth aspects. In the seventh aspect, the width of each of the plurality of fuses (6) falls within a range equal to or greater than −80% and equal to or less than +80% with respect to an average width of the plurality of fuses (6) as a reference value. The length of each of the plurality of fuses (6) falls within a range equal to or greater than −80% and equal to or less than +80% with respect to an average length of the plurality of fuses (6) as a reference value.

This aspect makes it easier to equalize the sensitivities of all the fuses (6) with each other, thus reducing the chances of causing an excessive decrease in the capacitance of the film capacitor (10A).

Specific examples of the metallized film (1) according to the seventh aspect include the first to ninth variations described above.

An eighth aspect is a film capacitor (10A) which includes the metallized film (1) according to any one of the first to seventh aspects.

This aspect makes it easier to realize a low ESR.

A ninth aspect is an inverter (10B) which includes the film capacitor (10A) according to the eighth aspect.

This aspect may improve the efficiency of the circuit and thereby minimize the power loss.

A tenth aspect is a vehicle (10C) which includes the inverter (10B) according to the ninth aspect.

This aspect may reduce the heat generated by the film capacitor (10A) to the point of extending the life of the film capacitor (10A), thus allowing for decreasing the frequency of repair and replacement of the film capacitor (10A).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A metallized film comprising: a dielectric film, for which a longitudinal direction and a width direction are defined; and a metal film provided on the dielectric film,
the metal film including: a larger electrode extending in the longitudinal direction; two or more columns of smaller electrodes arranged side by side in the width direction with respect to the larger electrode; and a plurality of fuses,
each of the two or more columns of smaller electrodes including a plurality of smaller electrodes that are arranged in the longitudinal direction,
each of the plurality of fuses connecting together either:
the larger electrode and a corresponding one of the smaller electrodes which is adjacent to the larger electrode; or
adjacent ones of the smaller electrodes,
a numerical number of the fuses connected to each of the plurality of smaller electrodes being equal to a numerical number of the fuses connected to any other one of the plurality of smaller electrodes, and
each of the plurality of smaller electrodes included in one of the two or more columns of smaller electrodes that is located closer to the larger electrode in the width direction than any other one of the two or more columns of smaller electrodes being connected to the larger electrode via two or more of the plurality of fuses.

2. The metallized film of claim 1, wherein
two smaller electrodes located adjacent to each other in the longitudinal direction which belong to the plurality of smaller electrodes included in an outer column are connected to each other via a corresponding one of the plurality of fuses, the outer column being located more distant in the width direction from the larger electrode than any other one of the two or more columns of smaller electrodes.

3. The metallized film of claim 1, wherein
two smaller electrodes located adjacent to each other in the longitudinal direction which belong to each of the two or more columns of smaller electrodes but an outer column are not connected via any of the plurality of fuses, the outer column being located more distant in the width direction from the larger electrode than any other one of the two or more columns of smaller electrodes.

4. The metallized film of claim 1, wherein
a numerical number of the fuses connected to each of the plurality of smaller electrodes is four.

5. The metallized film of claim 1, wherein
in two columns of smaller electrodes which are adjacent to each other in the width direction, each of the smaller electrodes included in one of the two columns of smaller electrodes and corresponding ones of the smaller electrodes included in a remaining one of the two columns of smaller electrodes are misaligned with each other in the width direction.

6. The metallized film of claim 1, wherein
in each of the plurality of smaller electrodes included in a column of smaller electrodes located closer in the width direction to the larger electrode than any other one of the two or more columns of smaller electrodes, a numerical number of the fuses connected to the larger electrode is larger than a numerical number of the fuses connected to any other one of the plurality of smaller electrodes.

7. The metallized film of claim 1, wherein
width of each of the plurality of fuses falls within a range equal to or greater than −80% and equal to or less than +80% with respect to an average width of the plurality of fuses as a reference value, and
length of each of the plurality of fuses falls within a range equal to or greater than −80% and equal to or less than +80% with respect to an average length of the plurality of fuses as a reference value.

8. A film capacitor comprising the metallized film of claim 1.

9. An inverter comprising the film capacitor of claim 8.

10. A vehicle comprising the inverter of claim 9.
